(19) United States
(12) Patent Application Publication
(10) Pub. No.: US 2017/0045026 A1
(43) Pub. Date: Feb. 16, 2017

(54) DEEP WATER POWER GENERATION STATION, POWER STATION, MARINE POWER PLANT AND OFFSHORE FLOATING CITY THEREOF

(71) Applicants: Zupeng FANG, Nanjing (CN); Dan FANG, Nanjing (CN); Yafeng ZHAO, Nanjing (CN); Lei WANG, Nanjing (CN); Fang FANG, Nanjing (CN)

(72) Inventors: Zupeng FANG, Nanjing (CN); Dan FANG, Nanjing (CN); Yafeng ZHAO, Nanjing (CN); Lei WANG, Nanjing (CN); Fang FANG, Nanjing (CN)

(21) Appl. No.: 15/232,628

(22) Filed: Aug. 9, 2016

(30) Foreign Application Priority Data
Aug. 10, 2015 (CN) 201510484265.8
Nov. 9, 2015 (CN) 201510752194.5
Jul. 1, 2016 (CN) 201610512676.8

(51) Int. Cl. F03B 13/00; H02K 7/18

(52) U.S. Cl. CPC F03B 13/00; H02K 7/1823; B63B 35/44

(57) ABSTRACT

A deep water power generation station, a power station, a marine power plant and an offshore floating city thereof includes a water tunnel pipe, where a length H is in a range of 0≦H≦10000 m; an upper end of the water tunnel pipe is connected to a hydraulic turbine through a horizontal water tunnel pipe, the hydraulic turbine is connected to a generator through a coupler, the hydraulic turbine is installed on a ship, a lower end of the water tunnel pipe is in communication with a horizontal speed-increasing water inlet pipe, the horizontal speed-increasing water inlet tunnel pipe is hung on the vertical speed-increasing water tunnel pipe through a bearing, an upper end of the water tunnel pipe is provided with a sealing top cover having an adjustable valve, and the rear of the water inlet pipe is connected to a flake-like steering empennage.

### BACKGROUND

Technical Field

The present invention relates to the field of hydraulic machinery, in particular, to a hydraulic turbine power generation station using a deep sea energy speed-increasing water tunnel, a power station, a marine power plant, and an offshore floating city thereof.

Related Art

A deep water power generation station, a power station, and an offshore floating city thereof use hydraulic energy provided by a deep water speed-increasing water tunnel. The power generation station, the power station, and the offshore floating city thereof are based on the principle of Archimedes hydraulic press: any point inside a closed container has an equal liquid pressure, that is, in a speed-increasing water tunnel, a flow rate is inversely proportional to a sectional area F: F1V1=F2V2 (for details, see page 19 of [symbol] [symbol] [symbol] by E. M. ΦATEB), and convert the low-speed or zero-speed static energy, high potential energy, and high static pressure energy into high-speed kinetic energy by using the motion conversion law and the Bernulli's equation, so as to drive a hydraulic turbine to generate power or serve as a marine power plant or other power plants, and derive a Fang deep water dynamic equation, where a water depth pipe H may be 10,000 m below the water surface, a unit power may reach over one million KW. The vast ocean is an inexhaustible energy reservoir, and people should never fight against each other for energy resources.

Up to date, most hydropower stations uses a hydraulic turbine generating set which has a water level difference due to a high-level water dam, and such naturally formed high-level water sources will be used up; therefore, people turn to oceans.

The inventor has applied for a water tunnel speed-increasing hydraulic machinery entitled “Water Level Flow Speed-increasing Generating Station, Power Station, Water Supply station, and Offshore Floating City”, where the Chinese Application No. is 2014102466858, the French Application No. is 3013029, the US application No. is US2015/0132151A1, and the Australian Application No. is AU2014218435.

The content of the present invention and the content of the prior application may supplement each other properly, and the present invention emphasizes acquisition of energy from the deep sea, and achieves a more evident speed increasing effect.

According to the content described above, the present invention can be used as an ultra-large hydropower station, and can also be used as a driving force and energy supplement vessel and an underwater operation vessel or a diving apparatus of a giant ship.

An offshore floating city having 2-30 generator sets can not only provide a station capacity like that of the Three Gorges hydroelectric power station but also allow migrants to live off and carry out agricultural production.

The above described generating set not only can supply power to the land through a seafloor cable, but also can provide electric energy in various electric power storage manners.

### SUMMARY

An objective of the present invention is to provide a deep water power generation station, a power station, a marine power plant, and an offshore floating city thereof.

Technical solutions adopted in the present invention include:

A deep water power generation station, a power station, a marine power plant, and an offshore floating city thereof include a vertical speed-increasing water tunnel pipe 9 that increases a water velocity from V₁≦0-1 m/sec to V₂≧200 m/sec, where a length H of the water tunnel pipe 9 is in a range of 0≦H≦10000 m; an upper end of the water tunnel pipe 9 is connected to a hydraulic turbine 3 through a horizontal water tunnel pipe 10, and the hydraulic turbine 3 is connected to a generator 1 through a coupler 2, to provide a hydropower station formed by a power source; alternatively, the horizontal water tunnel pipe 10 provides a power source to a driving turbine of a propeller 5 of a ship 4 by using a parallel pipe, and the hydraulic turbine 3 is installed on the ship 4; a lower end of the water tunnel pipe 9 is in communication with a horizontal speed-increasing water inlet pipe 6, the horizontal speed-increasing water inlet tunnel pipe 6 is hung on the vertical speed-increasing water tunnel pipe 9 by means of a bearing 7, a sealing top cover 23 with an adjustable valve is provided near the water-surface upper end of the water tunnel pipe 9, and the rear of the water inlet pipe 6 is connected to a flake-like steering empennage 8, so that the water inlet pipe 6 is constantly parallel to a water flow direction and rotates around an axis of the water tunnel pipe 9; the water tunnel pipe 9 is a tapered barrel or a cylindrical barrel, and a central axis of the water tunnel pipe 9 is vertical, inclined at a random angle, or spiral; a speed increasing ratio of a tapper pipe is 1-10000; the water tunnel pipe 9 is installed in such a manner as being fixed to the seafloor or in a floating manner, and the material of the water tunnel pipe 9 is a ferrous metal, a non-ferrous metal, ceramic, a plastic alloy, or armored concrete.

A ship with a sealed enclosure 15 in the present invention can perform an underwater operation, or a ship has a double-layer casing made of the water tunnel 9, and a driving turbine is used to provide power to the ship; when multiple generator sets are arranged in a building 12, a lower portion of a platform 24 is fixed to the seafloor 14 through a pile 13; each generator set is provided with a high-speed water source by using a series of separate speed-increasing water tunnel elements 6, 7, 8, 9 and 10 or may be provided with a water source in a parallel manner; a unit power of the generator 1 ranges from 5,000 KW to more than 1 million KW, the number of the buildings 12 installed with generators may be 2 to more than 30, forming an offshore floating city providing a total power of tens of millions of kilowatts; in addition to power generation, the hydraulic turbine can also be connected to and drive an agricultural production apparatus; and when the horizontal speed-increasing water tunnel 10 is not connected to the hydraulic turbine 3 but tilts upward to inject water to a water guide groove on the land to form a water source station, the present invention is applicable to the field of rivers, lakes and oceans.

An area of the static offshore floating city 24 may reach several square kilometers, and the offshore floating city can provide a power source for living and industrial and agricultural production of residents.

When the water tunnel pipe 9 is connected to the ship 4, the water tunnel pipe 9 is made to be a water tunnel having a water-drop-shaped cross section with a small forward resistance, and the water tunnel pipe is of a linear type or an axially contracting type.

No horizontal speed-increasing pipe 6 is arranged at the lower end of the speed-increasing water tunnel pipe 9.

End surfaces of the water tunnel pipe 9 and the water inlet pipe 6 are each additionally provided with an obstacle clearing apparatus with a strainer 16 and a spiral self-rotating blade 15.

A means for balancing an axial force of the water tunnel pipe 9 is: fixed bonding with the seafloor or a static object nearby, balancing with multiple suspended-cable weights or the self-weight of the ship.

The present invention has the following beneficial effects:

In the present invention, the low-speed or zero-speed static energy, high potential energy, and high static pressure energy is converted into high-speed kinetic energy by using the principle of Archimedes hydraulic press, the motion conversion law and the Bernulli's equation, so as to drive a hydraulic turbine to generate power or serve as a marine power plant or other power plants, and derive a Fang deep water dynamic equation, where a water depth pipe H may be 10,000 m below the water surface, a unit power may reach over one million KW. The vast ocean is an inexhaustible energy reservoir. The present invention provides inexhaustible clean energy resources for human beings, to prevent human beings from waging wars for energy resources.

### BRIEF DESCRIPTION OF THE DRAWINGS

FIG. 1 is an apparatus in which a speed-increasing water tunnel pipe 9 provides energy of a hydraulic turbine 3 and energy of a propeller 5 to a running ship 4 according to the present invention;

FIG. 2 is a principle diagram of a speed-increasing water tunnel pipe 9 provides energy to a generating set on a static platform 24 at sea;

FIG. 3 is a schematic diagram of an apparatus of the present invention arranged on an offshore floating city;

FIG. 4 is a cross sectional view of a water tunnel pipe 9 and a water tunnel pipe 6;

FIG. 5 is a floating object filtering apparatus disposed at water inlets of a water tunnel pipe 9 and a water tunnel pipe 6;

FIG. 6 is a schematic structural diagram of an axially contracting speed-increasing according to the present invention;

FIG. 7 is an automatic rotating sleeve pipe;

FIG. 8 is an installation structure of a water tunnel pipe that is fixedly bonded with a ground pile and positioned by using a circumferential steel rope.

FIG. 9 is a schematic diagram illustrating that the present invention and a hydraulic turbine of an existing hydropower station generate power in parallel;

FIG. 10 is a power generation station, which is on a barrage, newly added to an existing hydropower station; and

FIG. 11 is an installation schematic diagram of a sealing top cover 23 with an inner sleeve 49 and an adjustable valve 50.

In the figures, 1 represents a generator, 2 represents a coupler, 3 represents a hydraulic turbine, 4 represents a ship, 5 represents a ship propeller, 6 represents a horizontal speed-increasing water tunnel pipe, 7 represents a bearing, 8 represents a steering empennage, 9 represents a water tunnel pipe, 10 represents a horizontal water tunnel pipe, 11 represents a ship rudder, 12 represents a generator building, 13 represents a pile, 14 represents a underwater land, 15 represents a automatic rotating spiral loam board, 16 represents a strainer, 17 represents a bearing, 18 represents a bearing, 19 represents a bearing, 20 represents a cylindrical barrel, 21 represents a tapered barrel, 22 represents a seal ring, 23 represents a sealing top cover with an adjustable valve, 24 represents an offshore floating city, 25 represents an automatic rotating sleeve pipe head, 26 represents an automatic rotating sleeve pipe steering tail, 27 represents a water inlet, 28 represents a traction pile, 29 represents a ground pile, 30 represents a steel rope, 31 represents a newly added high-level turbine, 32 represents a newly added long transmission shaft, 33 represents an original generator, 34 represents an original turbine, 35 represents a steel rope, 36 represents a weight, 37 represents a metal flexible coil pipe, 38 represents a turbine drain pipe, 39 represents a turbine water inlet pipe of an existing hydropower station, 40 represents an existing power plant barrage reconstruction, 41 represents a water level in a reservoir, 42 represents a water level outside the reservoir, 43 represents a underwater ground, 44 represents a newly added barrage structural member, 45 represents an existing hydropower station barrage, 46 represents a newly added power generation room building, 47 represents a pressure sensor, 48 represents a speed sensor, 49 represents an inner sleeve, 50 represents an adjustable valve (in a butterfly shape or another shape), 51 represents a support bearing block, 52 represents a self-locking reducer, 53 represents a motor, 54 represents a support, and 55 represents a turbo space.

### DETAILED DESCRIPTION

The present invention is described in further detail below with reference to the accompanying drawings and the embodiments.

### Embodiment 1

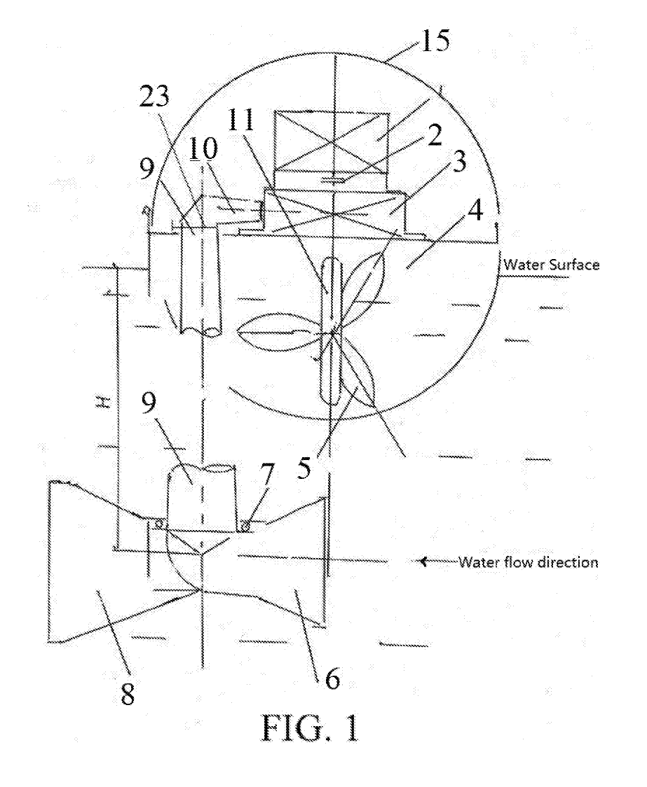

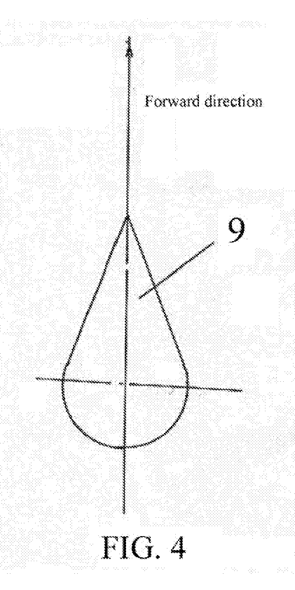

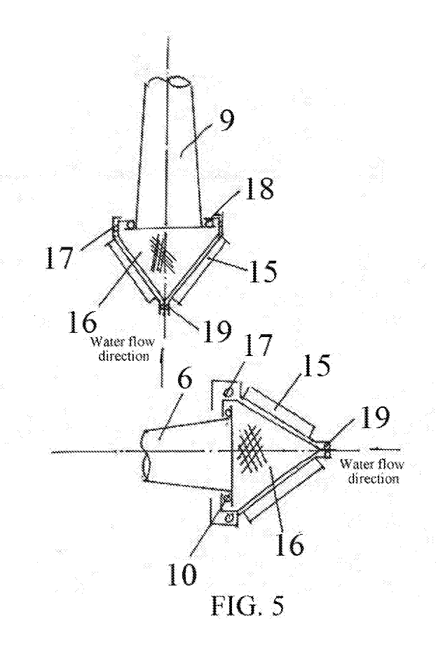

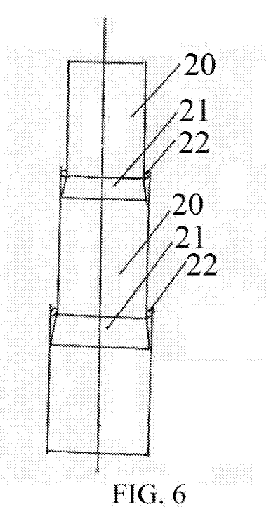

See FIG. 1, FIG. 4, FIG. 5, and FIG. 6.

A deep water power generation station, a power station, and a marine power plant include a vertical speed-increasing water tunnel pipe 9 that increases a water velocity from V₁≦0-1 m/sec to V₂≧200 m/sec, where a length H of the water tunnel pipe 9 is in a range of 0≦H≦10000 m; an upper end of the water tunnel pipe 9 is connected to a hydraulic turbine 3 through a horizontal water tunnel pipe 10, and the hydraulic turbine 3 is connected to a generator 1 through a coupler 2, as shown in FIG. 1, to provide a hydropower station formed by a power source; alternatively, the horizontal water tunnel pipe 10 provides a power source to a driving turbine of a propeller 5 of a ship 4 by using a parallel pipe, and the hydraulic turbine 3 is installed on the ship 4; a lower end of the water tunnel pipe 9 is in communication with a horizontal speed-increasing water inlet pipe 6, the horizontal speed-increasing water inlet tunnel pipe 6 is hung on the vertical speed-increasing water tunnel pipe 9 by means of a bearing 7, a sealing top cover 23 with an adjustable valve is provided at the upper end of the water tunnel pipe 9, and the rear of the water inlet pipe 6 is connected to a flake-like steering empennage 8, so that the water inlet pipe 6 is constantly parallel to a water flow direction and rotates around an axis of the water tunnel pipe 9; the water tunnel pipe 9 may be a tapered barrel or a cylindrical barrel, and a central axis of the water tunnel pipe 9 is vertical, inclined at a random angle, or spiral; a speed increasing ratio of a tapper pipe is 1-10000; the water tunnel pipe 9 is installed in such a manner that the upper end thereof is fixedly bonded to the bottom of the ship, the lower end thereof is provided with a weight or is fixedly bonded with the seafloor, and the material of the water tunnel pipe 9 is a ferrous metal, a non-ferrous metal, ceramic, a plastic alloy, or armored concrete.

A ship with a sealed enclosure 15 in the present invention can perform an underwater operation, or a ship has a double-layer casing made of the water tunnel 9, and a driving turbine is used to provide power to the ship; in addition to power generation, the hydraulic turbine can also be connected to and drive an agricultural production apparatus; and when the horizontal speed-increasing water tunnel 10 is not connected to the hydraulic turbine 3 but tilts upward to inject water to a water guide groove on the land to form a water source station, the present invention is applicable to the field of rivers, lakes and oceans. When the water tunnel pipe 9 is connected to the ship 4, the water tunnel pipe 9 is made to be a water tunnel having a water-drop-shaped cross section with a small forward resistance, as shown in FIG. 4, and the water tunnel pipe is of a linear type or an axially contracting type. End surfaces of the water tunnel pipe 9 and the water inlet pipe 6 are each additionally provided with an obstacle clearing apparatus with a strainer 16 and a spiral self-rotating blade 15. A means for balancing an axial force of the water tunnel pipe 9 is: fixed bonding with the seafloor or a static object nearby, balancing with multiple suspended-cable weights or the self-weight of the ship.

### Embodiment 2

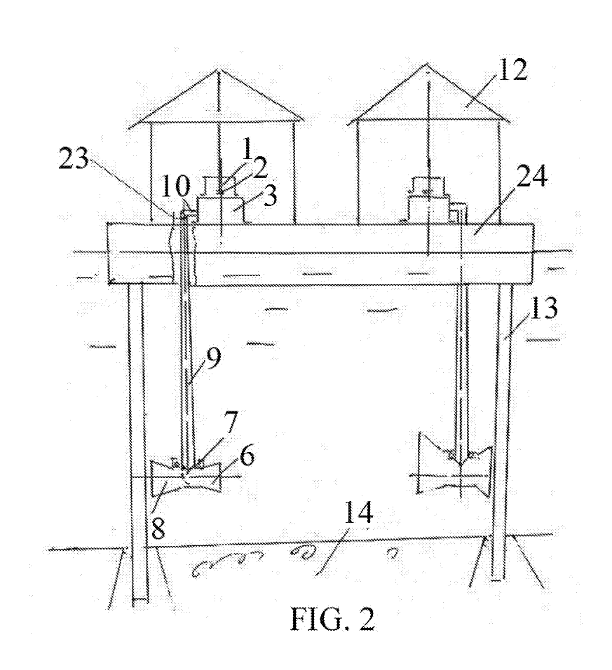

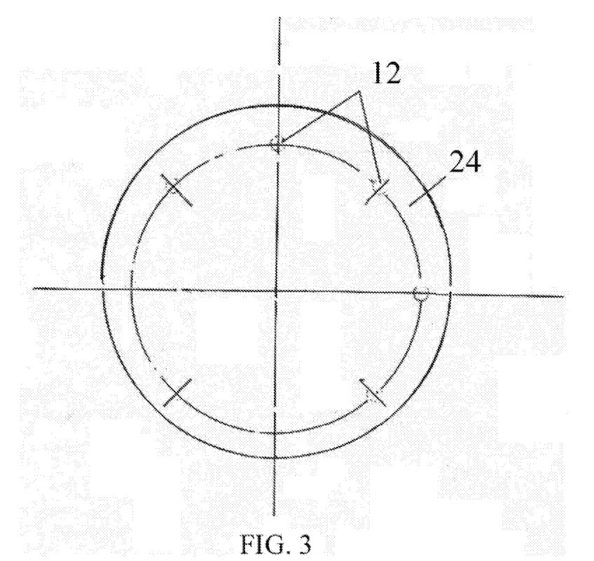

Refer to FIG. 2, FIG. 3, FIG. 4, FIG. 5, and FIG. 6.

A deep water power generation station, a power station, a marine power plant and an offshore floating city thereof include a vertical speed-increasing water tunnel pipe 9 that increases a water velocity from V₁≦0-1 m/sec to V₂≧200 m/sec, where a length H of the water tunnel pipe 9 is in a range of 0≦H≦10000 m; an upper end of the water tunnel pipe 9 is connected to a hydraulic turbine 3 through a horizontal water tunnel pipe 10, and the hydraulic turbine 3 is connected to a generator 1 through a coupler 2, to provide a hydropower station formed by a power source, so as to supply power to the offshore floating city and ensure electric energy required for normal living on the offshore floating city; the hydraulic turbine 3 is installed on the offshore floating city 24; a lower end of the water tunnel pipe 9 is in communication with a horizontal speed-increasing water inlet pipe 6, the horizontal speed-increasing water inlet tunnel pipe 6 is hung on the vertical speed-increasing water tunnel pipe 9 by means of a bearing 7, a sealing top cover 23 with an adjustable valve is provided near the water-surface upper end of the water tunnel pipe 9, and the rear of the water inlet pipe 6 is connected to a flake-like steering empennage 8, so that the water inlet pipe 6 is constantly parallel to a water flow direction and rotates around an axis of the water tunnel pipe 9; the water tunnel pipe 9 may be a tapered barrel or a cylindrical barrel shown in FIG. 6, and a central axis of the water tunnel pipe 9 is vertical, inclined at a random angle, or spiral; a speed increasing ratio of a tapper pipe is 1-10000; the water tunnel pipe 9 is installed in such a manner as being fixed to the seafloor through a pile 13, in a manner in which the lower end of the water tunnel pipe 9 is provided with a weight or in a floating manner, and the material of the water tunnel pipe 9 is a ferrous metal, a non-ferrous metal, ceramic, a plastic alloy, or armored concrete.

In this embodiment, multiple generator sets are arranged in a generator building 12, a lower portion of a platform 11 is fixed to the seafloor 14 through a pile 13; each generator set is provided with a high-speed water source by using a series of separate speed-increasing water tunnel elements 6, 7, 8, 9 and 10 or may be provided with a water source in a parallel manner, as shown in FIG. 2; a unit power of the generator 1 ranges from 5,000 KW to more than 1 million KW, the number of the buildings 12 installed with generators may be 2 to more than 30, forming an offshore floating city providing a total power of tens of millions of kilowatts; in addition to power generation, the hydraulic turbine can also be connected to and drive an agricultural production apparatus; and when the horizontal speed-increasing water tunnel 10 is not connected to the hydraulic turbine 3 but tilts upward to inject water to a water guide groove on the land to form a water source station, the present invention is applicable to the field of rivers, lakes and oceans. When the water tunnel pipe 9 is connected to the ship 4, the water tunnel pipe 9 is made to be a water tunnel having a water-drop-shaped cross section with a small forward resistance, as shown in FIG. 4, and the water tunnel pipe is of a linear type or an axially contracting type. End surfaces of the water tunnel pipe 9 and the water inlet pipe 6 are each additionally provided with an obstacle clearing apparatus with a strainer 16 and a spiral self-rotating blade 15. A means for balancing an axial force of the water tunnel pipe 9 is: fixed bonding with the seafloor, balancing with multiple suspended-cable weights or the self-weight of the ship.

An area of the static offshore platform 11 may reach several square kilometers, and the offshore floating city can provide a power source for living and industrial and agricultural production of residents.

### Embodiment 3

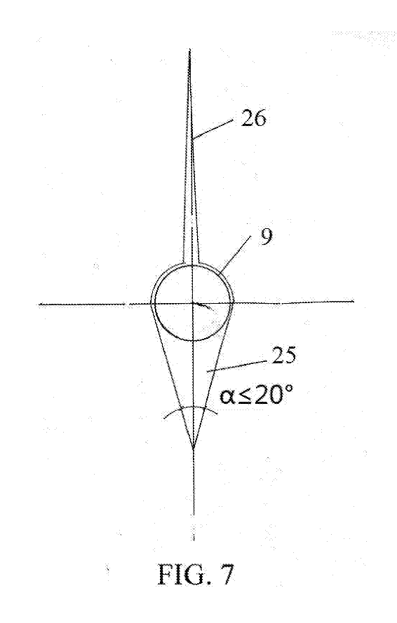

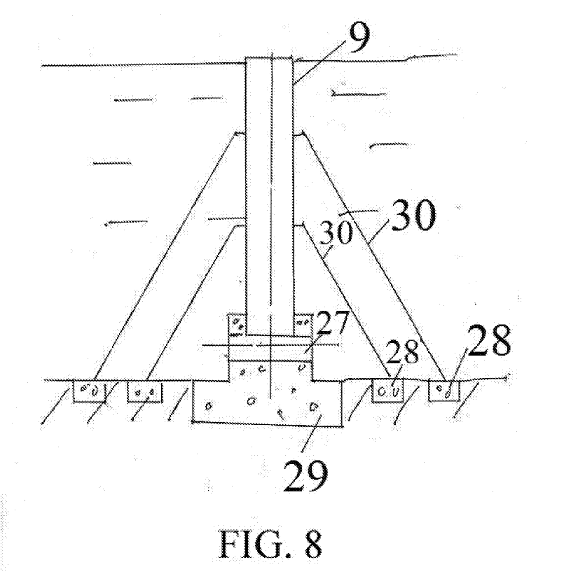

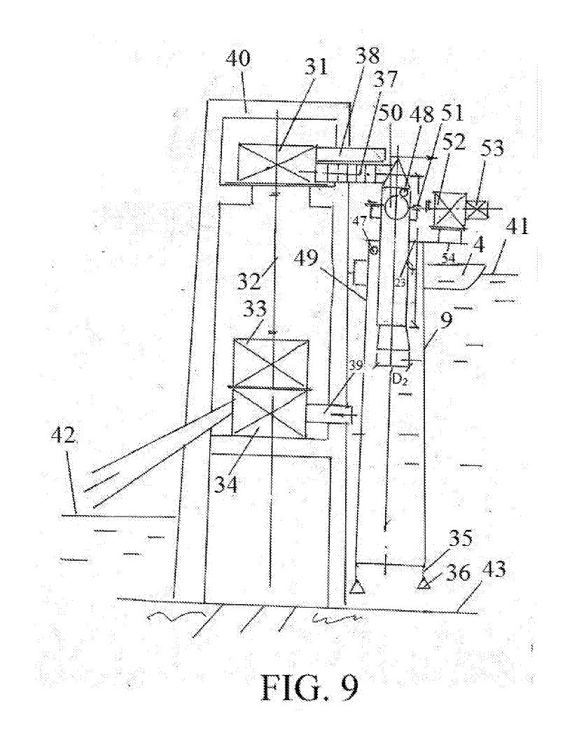

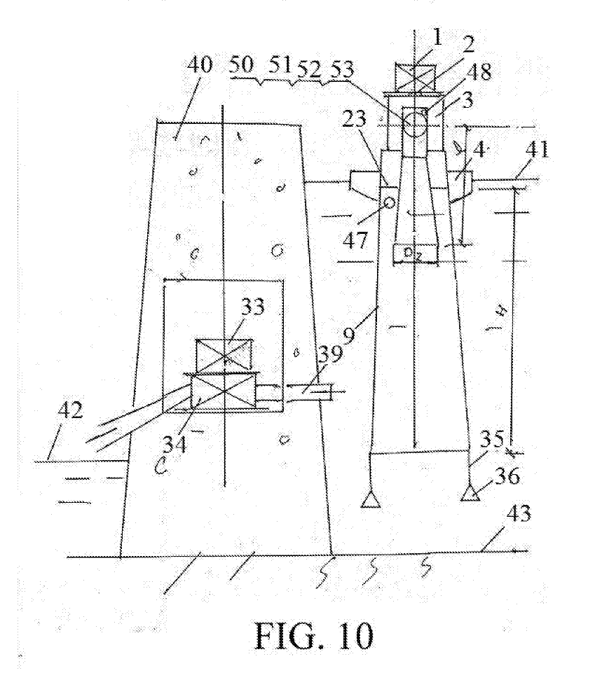

Refer to FIG. 7 to FIG. 11.

The present invention is different from Embodiment 1 and Embodiment 2 in that the structure of the water tunnel pipe is further defined to rapidly increase a velocity at the bottom of the water tunnel pipe 9 from 0 to 200 meters.

A stress state and the structure of the water tunnel pipe 9 are described as follows:

a. A static pressure pₒᵤₜₑᵣ outside the wall increases linearly from 0 to pₘₐₓ as the depth H increases, and both upper and lower portions inside the wall are in a pₘₐₓ maximum pressure state; therefore, the stressed state of the upper portion is inferior to the lower portion; an actual stress on each cross section is pᵢₙₙₑᵣ−pₒᵤₜₑᵣ (kg/m²); as a cylindrical casing. an axial stress thereof is

$${1}_{} = \frac{pR}{2 h} ,$$

and a circumferential stress thereof is

$${2}_{} = \frac{pR}{h} ,$$

where R in the formula is the radius (cm) of the cross section of the water tunnel pipe 9, h is the thickness (cm) of the wall, and the p is the intensity of pressure (kg/cm²).

b. The wall of the water tunnel pipe 9 may be made into a solid with a constant thickness or strength; a solid with a trapezoid cross section, where an upper portion is a thick double-layer complex and a lower portion is a thin solid; or a double-layer complex having a trapezoid cross section whose overall axial thickness is thin in a lower portion and thick in an upper portion.

c. When the water tunnel pipe 9 has a long depth and need to be made of preformed members segment by segment, rust-proof flanges need to be disposed on each segment, the two flanges are each provided with a static sealing element and a rust-proof connection element.

d. In rivers, lakes and seas with horizontal flows, an outer wall of the water tunnel pipe 9 is sleeved segment by segment with a flow guide sleeve pipe capable of automatically rotating around the outer wall of the water pipe, where an acute angle of the sleeve pipe is less than or equal to 20′; the sleeve pipe is a two-piece assembly that can be split along an axial direction to facilitate assembly and disassembly, so that a resistance system is reduced from 0.75 to 0.16; and a vertical total length is arranged segment by segment in a same manner as the water tunnel pipe 9.

e. A traction pile at a lower portion of the water tunnel pipe 9 fixedly bonded to the seafloor is preferably a concrete structural member, and is buried under the seafloor to avoid being affected by a water flow, where the traction pile and the lower end of the water tunnel pipe 9 may be connected by using a steel rope, or may be rigidly connected by using a rigid member with an axial window.

When a depth H of the water tunnel pipe 9 is extremely deep, in a flowing water area environment, a circumference of a conjunction of the preformed member of the water tunnel pipe 9 is provided with a group of traction steel ropes 30 with circumferential equal angles and vertical depression angles, the other end of each steel rope 30 is buried in the seafloor through the traction pile 28. The lower end of the water tunnel pipe 9 is fixedly bonded on a ground pile 29 with a radial water inlet 27.

f. When a nozzle at the upper portion of the water tunnel pipe 9 matches the turbine, a conventional radial flow nozzle or axial flow nozzle is used.

g. When the depth of the water tunnel pipe 9 disposed in a shallow lake or ocean is greater than a natural water depth (for example, in China, the Lake Tai has a depth of 4-5 meters, Dongting Lake has a depth of 30 meters, and Bohai Sea has a depth of 50 meters), a deep water well may be dug at the bottom, and cobblestones or a concrete structural member is laid at the bottom of the well.

h. As a hydropower station apparatus, the present invention can be disposed at an inner side of a barrage of a reservoir of an existing hydropower station, where a high-level turbine 31 driven by an upper portion outlet of the water tunnel pipe 9 and an upper portion 32 of a generator of the existing hydropower station coaxially form a dual-drive power generation system with upper (the newly added high-level turbine 31 driven by the water tunnel pipe 9 of the present invention) and lower (a hydraulic turbine 34 in the existing hydropower station) generators 33. Water flowing out of the turbine may return to the reservoir or drive respective generators to form a capacity extension power plant, so that the present invention can adjust the defect in a dry season, and a well may be dug when the depth of the reservoir is insufficient. In this way, no grids and power transmission systems need to be added; the existing hydropower station has a long dry season, which is generally over 50%; by means of parallel power generation or separate capacity extension, the generating capacity can be doubled or increased by a greater value, and besides, the reservoir can constantly maintain a high-level state; for example, the water level of the Three Gorges hydropower station is 175 meters. As the turbine and the generator of the present invention are in the high-level state, and water discharged from the turbine can return to the reservoir, if a separate capacity extension scheme is used, the installed capacity of the existing hydropower station can be increased by at least 100%, and static water does not affect a lateral pressure of the water tunnel pipe 9; a new barrage structural member 44 is added to fixedly bond the water tunnel pipe on the inner side of the barrage to support the weight of the water tunnel pipe 9 and an upward static pressure in the water tunnel pipe 9; an opening speed and size of sealing top cover 23, which has the adjustable valve, at the upper end of the water tunnel pipe 9 are subject to computer automated adjustment according to a velocity in the horizontal water tunnel pipe 10 and a signal sent by a pressure gauge throughout a whole process from a completely closed state to a completely open state (slow startup).

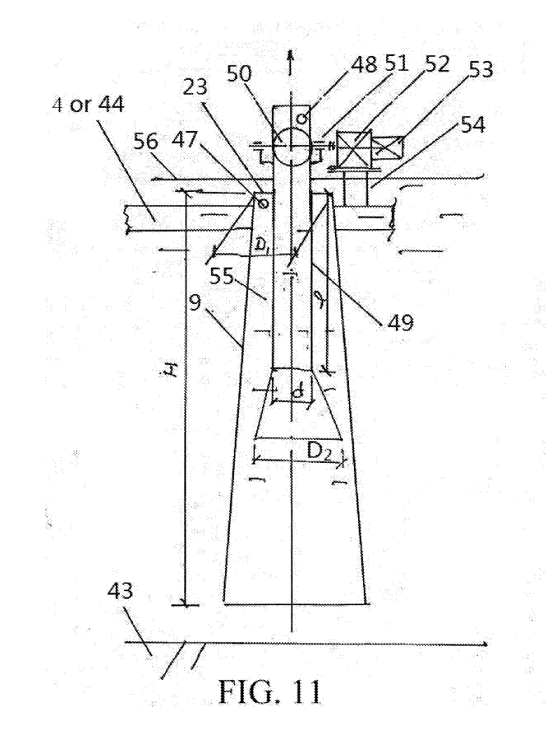

Refer to FIG. 11. An inner sleeve 49 with a tapper pipe at a lower end is installed at a middle portion of the sealing top cover 23 below a water surface 56, where a major diameter D2 of the tapper pipe is less than an inner diameter of the water tunnel pipe 9 by 10-20%, a ratio of a diameter d of the inner sleeve 49 to a diameter D₂ of the sealing top cover 23 is 0.8-0.4, and a length ratio l/H between the inner sleeve 49 and the sealing top cover 23 is about 0.05-0.2, forming a turbo space 55 on an outer wall of the inner sleeve 49, on an inner wall of the water tunnel pipe 9, and below the sealing top cover 23, and the turbo air 55 maintains a constant high pressure in the lower end of the water tunnel pipe. A top portion thereof is provided with a pressure sensor 47, and a water-surface upper portion of the inner sleeve is provided with an adjustable valve 50; two ends thereof are supported in two bearing blocks 51, where one end is connected to a self-clocking reducer 52 through a coupler, another end of the reducer 52 is connected to a motor 53, a speed sensor 48 is installed at an outlet of the adjustable valve 50, and an opening degree of the adjustable valve is subject to computer automated control according to signals of two sensors.

When a cylindrical and a slightly-tapered water tunnel pipe 9 is used, an inner sleeve 49 and a corresponding control means are arranged in the sealing top cover 23; in a case of a significantly-tapered water tunnel pipe 9, no inner sleeve is arranged in the sealing top cover, an inner side of the water tunnel pipe should be provided with a pressure sensor 47, and an external side of the water tunnel pipe should be provided with a valve 50, a support bearing block 51, a reducer 52, a motor 53, and a speed sensor 48 as well as a corresponding computer automated control means.

When the inner sleeve 49 is provided, the water tunnel pipe 9 is positioned by upper and lower related structural members, a turbo space is formed between the inner sleeve 49 and inner wall at the upper portion of the water tunnel pipe 9; under the effect of the turbo space 55, a pressure accumulator with a high-pressure space is formed, and according to the principle of Archimedes hydraulic press, an equal inner intensity of pressure is achieved, where the value is H (m).

After the adjustable valve 50 is open, the intensity of pressure at the lower end of the inner sleeve 49 is H, the pressure above the plane of the lower end is l, and therefore, the inner sleeve ejects a spout with a pressure of H−l (m), and the spout exists forever.

When the lower end of the water tunnel pipe 9 is provided with the horizontal speed-increasing pipe 6 and is in a water flowing environment, after speed increasing of the speed-increasing pipe 6 and the speed increasing effect of the water tunnel pipe, an initial speed thereof is converted into an outlet speed increasing effect at the upper end of the water tunnel pipe 9.

The principle of the present invention is as follows:

\textcircled{1} In a startup stage, based on the principle of Archimedes hydraulic press, the water tunnel pipe 9 is in a relatively fixed state and the top cover on the upper portion thereof is in a completely closed state, and water enters therein from an opening at the lower portion of the water tunnel pipe 9; after the intensity of pressure in the upper portion of the water tunnel pipe 9 is equal to that of the lower portion thereof, according to the Bernulli's equation, the static pressure P (kg/m²) can be converted into a velocity V (m/sec); the adjustable valve of the sealing top cover 23 at the upper portion of the water tunnel pipe 9 is open, and according to the law of motion conversion of fluid in pipelines: a relationship between a velocity V1 at a cross section and an area F of the cross section is F₁V₁=F₂V₂=constant; therefore, the water tunnel pipe 9 that has a smaller cross section at the upper portion and a larger cross section at the lower portion achieves a speed increasing effect again. For details, see the low of motion conversion in page 19 of [symbol] [symbol] [symbol] (which means wind power generator and wind power dynamic apparatus in Russian), that is 3aKOH [symbol] [symbol] . E. M. ΦATEEB, written in 1956.

\textcircled{2} After the adjustable valve of the sealing top cover 23 at the upper portion of the water tunnel pipe 9 is open, according to the basic principle of the Bernulli's equation in hydromechanics:

H₁+p₁/ρ+V₁²/(2g)=H₂+p₂/ρ+V₂²/(2g)

In the foregoing formula, H1 and H2 represents heights in meters, ρ1 and ρ2 are the intensity of pressure at corresponding heights, in kg/m³, and a total dimension of p/ρ and V²/(2g) is m. The basic concept of the foregoing formula is that a sum of potential energy, kinetic energy and pressure energy at all cross sections of the water tunnel pipe 9 is constant, and the energy are convertible (for details, see page 74 of volume one of hydraulics, edited by Wu Chigong from Sichuan University; page 166 of volume one of fluid mechanics, written by Zhou guangjiong and so on; and pages 105 and 106 of FLUID MECHANICS, written by PIJUSH K. KUNDE and so on; where the formula 4.19 also as an error: the dimensions are not equal).

The high-pressure static energy at the upper portion of the water tunnel pipe 9 is converted into high speed kinetic energy. According to the basic principle of the Bernulli's equation, potential energy, kinetic energy and pressure energy of the fluid in the pipe are convertible. For example, energy of a 500 MW hydraulic turbine is: E=500000×102=51000000 kg-m, which also can be expressed as kinetic energy:

$$E = \frac{{mv}^{2}}{2} = \frac{ρ {F}_{1} {V}^{3}}{2 g} ;$$

ρ represents a ratio; V represents a water velocity (m/sec); F₁ represents an outlet cross section area (m²); when F=1 m², the velocity:

$$V = \sqrt[3]{\frac{2 gE}{F ρ}} = \sqrt[3]{\frac{2 \times 9.81 \times 51 \times {10}^{6}}{1000 \times 1}} = 100 m \text{/} sec .$$

In this way, when the water velocity V₁=1 m/sec (as shown in FIG. 1), a speed increasing ratio between the initial flow speed at the water surface and the speed-increasing water tunnel of the water tunnel pipe 9 is i₁=100, and an inlet area F2=100 m², the foregoing energy of 500 MW can be achieved; when energy is acquired from deep water, for example at a depth of H=20 m, the velocity at the water outlet is V=\sqrt{2gh}=19.8 m/sec, and then, the speed-increasing ratio of the speed-increasing water tunnel is

$${i}_{2} = \frac{100}{19.8} = 5.05 ,$$

and the outlet area is F₂=5.05 m². When the water tunnel pipe 9 is cylindrical, that is, F1=F2=1 m², and V=100 m/sec, the depth of the water tunnel pipe 9 is H=V²/(2g)=100²/(2×9.8)=509.68 m.

According to the Archimedes principle and the Bernulli's method, the outlet speed of the water tunnel pipe 9 is

$$V 2 = \frac{P}{ρ} ,$$

where P represents the intensity of pressure (kg/m²) and ρ represents the density of water, it can be obtained that V₂=\sqrt{2H₁g}; when the cross section area F=1 m², the kinetic energy at the height Z₂=0 is

$$E = \frac{{mv}^{2}}{2} = \frac{ρ {FV}^{3}}{2 g} = \frac{1000 {FV}^{3}}{2 g} = 50.96 {V}^{3} kg \text{-} m ,$$

and the power N=0.4996V³ KW; at a water depth of H₁=3000 m, the water surface outlet speed can read V=\sqrt{2H₁g}=242 m/sec, and the power can reach 7 million KW. The foregoing are generally referred to as deep water dynamics equation.

When the water ejection speed at the top of the water tunnel pipe 9 is required to be V₂≧200 m/sec, a design program of an original velocity V₂=0 at the lower end of the water tunnel pipe 9 is as follows:

a. Principle and General Design:

a-1: According to the principle of the Archimedes hydraulic press, the intensity of pressure Pᵤₚ (kg/m², upward) of the inner wall of the top sealing cover of the water tunnel pipe 9 is equal to the intensity of pressure P_{low} (kg/m²) at the lower end of the water tunnel pipe 9.

a-2: Considering the water tunnel pipe 9 as a free body, a combined force Pᵤₚ (kg, upward) of the intensity of pressure in the sealing cover at the upper end of the water tunnel pipe 9 is equal to a pulling force P_{down} (kg, downward) of the structural member, which is fixedly bonded to the seafloor, at the lower portion of the water tunnel pipe 9, that is, ΣY=0, Pᵤₚ↑=P_{down}↓; the force of the P_{down} may also be generated by the ship above, that is, the upper portion of the water tunnel pipe 9 is fixedly bonded to the ship and the lower portion is floating.

a-3: According to the Bernulli's method and principle, the water outlet velocity at the upper portion of the water tunnel pipe 9 may be converted from the intensity of static pressure Pᵤₚ, because Pᵤₚ=P_{down} (kg/m²). As is known to all, a relationship between the intensity of pressure ρ and depth H (m) of water is ρ=1000H kg/m², while the velocity is V₂=\sqrt{2Hg}: when it is required that V₂=200 m/sec, the depth of the water tunnel pipe 9 is: H=V²/(2g)=200²/(2×9.8)=2038.7 m (for cylindrical water tunnel pipe).

a-4: When the water tunnel pipe 9 is in a working condition of the speed increasing i, and the outlet velocity is still 200 m/sec, the depth of the water tunnel pipe 98 is H=(V₂/i)²/(2g), and when i=10, H=(200²/10)/(2×9.8)=20.38 m.

b. The Maximum Working Condition and Implementation of the Present Invention:

b-1: An existing diving operation tool “Jiaolong” has a maximum diving depth of 3000 meters, and as the technology advances, this depth will increase continuously; therefore, recently, a depth of the water tunnel pipe 9 is H≦3000 m.

b-2: If the water tunnel pipe 9 has a large depth H, it should be made of preformed members connected segment by segment, where the length of each segment is preferably 5-30 meters, the weight of each segment is G less than or equal to 500 tons, which is the maximum floating crane load capacity on water in China.

b-3: The maximum depth H of the water tunnel pipe 9 is 10000 meters, which is set to meet the maximum depths of the Pacific Ocean.

b-4: When the maximum depth H of the water tunnel pipe 9 is 10000 meters, the outlet velocity of the cylindrical pipe is V_{H=1000}=\sqrt{2×9.81×10000}=442.9 m/sec.

b-5. At the depth H=10000 meters (the deepest position under the Pacific Ocean), the outlet velocity at the upper portion of the tapered water tunnel pipe 9 can reach: V_{max (cylinder)}=\sqrt{2gH}=\sqrt{2×9.81×10000}=442.9 m/sec.

When the water tunnel pipe 9 is a tapered pipe, length H=10000 meters, and an area ratio between the lower and upper openings thereof (that is, the speed increasing ratio) i is 10000, then the outlet velocity is:

Vₘₐₓ₍ₜₐₚₑᵣ₎=442.9×10000=442.9×10⁴ m/sec

In this working condition, the outlet range is:

$$Smax = \frac{{[ Vmax ( taper ) ]}^{2}}{2 g} = 9.99 \times {10}^{11} m = 0.999 billion kilometers ,$$

where the power depends on the area of the outlet, and when the outlet area F₁=1 m², the energy is

$$E = \frac{{mV}^{2}}{2} = \frac{ρ {FV}^{3}}{2 g} = \frac{1000 \times 1 \times {( 442.9 \times {10}^{4} )}^{3}}{2 \times 9.81} = 4.428 \times 1 {0}^{21} kgm .$$

The power is N=(4.418×10²¹)/10²=4.34×10¹⁹ kW.

The stressed state of structure of the water tunnel pipe 9:

a. A static pressure pₒᵤₜₑᵣ outside the wall increases linearly from 0 to pₘₐₓ as the depth H increases, and both upper and lower portions inside the wall are in a pₘₐₓ maximum pressure state; therefore, the stressed state of the upper portion is inferior to the lower portion; an actual stress on each cross section is pᵢₙₙₑᵣ−pₒᵤₜₑᵣ (kg/m²); as a cylindrical casing, an axial stress thereof is

$${1}_{} = \frac{pR}{2 h} ,$$

and a circumferential stress thereof is

$${2}_{} = \frac{pR}{h} ,$$

where R in the formula is the radius (cm) of the cross section of the water tunnel pipe 9, h is the thickness (cm) of the wall, and the p is the intensity of pressure (kg/cm²).

b. The wall of the water tunnel pipe 9 may be made into a solid with a constant thickness or strength; a solid with a trapezoid cross section, where an upper portion is a thick double-layer complex and a lower portion is a thin solid; or a double-layer complex having a trapezoid cross section whose overall axial thickness is thin in a lower portion and thick in an upper portion

c. When the water tunnel pipe 9 has a long depth and need to be made of preformed members segment by segment, rust-proof flanges need to be disposed on each segment, the two flanges are each provided with a static sealing element and a rust-proof connection element.

d. In rivers, lakes and seas with horizontal flows, an outer wall of the water tunnel pipe 9 is sleeved segment by segment with a flow guide sleeve pipe capable of automatically rotating around the outer wall of the water pipe, where an acute angle of the sleeve pipe is less than or equal to 20°; the sleeve pipe is a two-piece assembly that can be split along an axial direction to facilitate assembly and disassembly, so that a resistance system is reduced from 0.75 to 0.16; and a vertical total length is arranged segment by segment in a same manner as the water tunnel pipe 9.

e. A traction pile at a lower portion of the water tunnel pipe 9 fixedly bonded to the seafloor is preferably a concrete structural member, and is buried under the seafloor to avoid being affected by a water flow, where the traction pile and the lower end of the water tunnel pipe 9 may be connected by using a steel rope, or may be rigidly connected by using a rigid member with an axial window

When a depth H of the water tunnel pipe 9 is extremely deep, in a flowing water area environment, a circumference of a conjunction of the preformed member of the water tunnel pipe 9 is provided with a group of traction steel ropes 30 with circumferential equal angles and vertical depression angles, the other end of each steel rope 30 is buried in the seafloor through the traction pile 28. The lower end of the water tunnel pipe 9 is fixedly bonded on a ground pile 29 with a radial water inlet 27.

f. When a nozzle at the upper portion of the water tunnel pipe 9 matches the turbine, a conventional radial flow nozzle or axial flow nozzle is used.

g. When the depth of the water tunnel pipe 9 disposed in a shallow lake or ocean is greater than a natural water depth (for example, in China, the Lake Tai has a depth of 4-5 meters, Dongting Lake has a depth of 30 meters, and Bohai Sea has a depth of 50 meters), a deep water well may be dug at the bottom, and cobblestones or a concrete structural member is laid at the bottom of the well.

h. As a hydropower station apparatus, the present invention can be disposed at an inner side of a barrage of a reservoir of an existing hydropower station, where a high-level turbine 31 driven by an upper portion outlet of the water tunnel pipe 9 and an upper portion 32 of a generator of the existing hydropower station coaxially form a dual-drive power generation system (which is a reselection on the prior art) with upper (the newly added high-level turbine 31 driven by the water tunnel pipe 9 of the present invention) and lower (a hydraulic turbine 34 in the existing hydropower station) generators 33. Water flowing out of the turbine may return to the reservoir or drive respective generators to form a capacity extension power plant, so that the present invention can adjust the defect in a dry season, and a well may be dug when the depth of the reservoir is insufficient. In this way, no grids and power transmission systems need to be added; the existing hydropower station has a long dry season, which is generally over 50%; by means of parallel power generation or separate capacity extension, the generating capacity can be doubled or increased by a greater value, and besides, the reservoir can constantly maintain a high-level state; for example, the water level of the Three Gorges hydropower station is 175 meters. As the turbine and the generator of the present invention are in the high-level state, and water discharged from the turbine can return to the reservoir, if a separate capacity extension scheme is used, the installed capacity of the existing hydropower station can be increased by at least 100%, and static water does not affect a lateral pressure of the water tunnel pipe 9; a new barrage structural member 44 is added to fixedly bond the water tunnel pipe on the inner side of the barrage to support the weight of the water tunnel pipe 9 and an upward static pressure in the water tunnel pipe 9; an opening speed and size of sealing top cover 23, which has the adjustable valve, at the upper end of the water tunnel pipe 9 are subject to computer automated adjustment according to a velocity in the horizontal water tunnel pipe 10 and a signal sent by a pressure gauge throughout a whole process from a completely closed state to a completely open state (slow startup).

Parts that are not involved in the present invention are the same as those in the prior art or may be implemented by using the prior art.

1. A deep water power generation station, a power station, a marine power plant, and an offshore floating city thereof, comprising a vertical speed-increasing water tunnel pipe that increases a water velocity from V₁≦0-1 m/sec to V₂≧200 m/sec, wherein an upper end of the water tunnel pipe is installed on a ship or installed on a structural member connected to barrage infrastructure or the land, a length H of the water tunnel pipe is in a range of 0≦H≦10000 m, a lower end of the water tunnel pipe is in a floating state (with a weight or without a weight) or is fixedly bonded to a ground pile having a water inlet, the upper end of the water tunnel pipe is connected to a hydraulic turbine through a horizontal water tunnel pipe, and the hydraulic turbine is connected to a generator through a coupler, to provide a hydropower station formed by a power source; alternatively, the horizontal water tunnel pipe provides a power source to a driving turbine of a propeller of a ship by using a parallel pipe, the hydraulic turbine is installed on the ship or is installed on a structural member connected to a barrage or the land, the lower end of the water tunnel pipe is in communication with a horizontal speed-increasing water inlet pipe, the horizontal speed-increasing water inlet tunnel pipe is hung on the vertical speed-increasing water tunnel pipe by means of a bearing, a sealing top cover with a valve subject to computer automated control and adjustment is provided near the water-surface upper end of the water tunnel pipe, and the rear of the water inlet pipe is connected to a flake-like steering empennage, so that the water inlet pipe is constantly parallel to a water flow direction and rotates around an axis of the water tunnel pipe; the water tunnel pipe is a tapered barrel or a cylindrical barrel, and a central axis of the water tunnel pipe is vertical, inclined at a random angle, or spiral; a speed increasing ratio of a tapper pipe of the water tunnel pipe is 1-10000; the water tunnel pipe is installed in such a manner that the lower end thereof is fixed to the seafloor or in a floating manner, and the material of the water tunnel pipe is a ferrous metal, a non-ferrous metal, ceramic, a plastic alloy, or armored concrete; the power generation station is of an independent type, a type of being connected to an existing hydropower station in parallel, or a type of being additionally disposed on an existing hydropower station in parallel, where one or more power generation stations may be arranged; the turbine drives other loads; in a super-far range water supply dynamic engineering without use of the turbine, at the upper end of the water tunnel pipe, a ball-spade pipe rotatable around the axis freely and a related automatic operation apparatus are arranged on an output plane of the sealing top cover having the adjustable valve; as an apparatus with a hundred-million-kilometer range, the present invention can be used to improve deserts, destroy a small planet, and supply a proper amount of water to the moon while alleviating the problem that coastal cities are going to be swamped by seawater as the sea level rises; as a hydropower station apparatus, the present invention can be disposed at an inner side of a barrage of a reservoir of an existing hydropower station, wherein a high-level turbine driven by an upper portion outlet of the water tunnel pipe and an upper portion of a generator of the existing hydropower station coaxially form a dual-drive power generation system with upper and lower generators; water flowing out of the turbine may return to the reservoir or drive respective generators to form a capacity extension power plant, so that the present invention can adjust the defect in a dry season, and a well may be dug when the depth of the reservoir is insufficient; in this way, no grids and power transmission systems need to be added; the existing hydropower station has a long dry season, which is generally over 50%; by means of parallel power generation or separate capacity extension, the generating capacity can be doubled or increased by a greater value, and besides, the reservoir can constantly maintain a high-level state; as the turbine and the generator are in the high-level state, and water discharged from the turbine can return to the reservoir, if a separate capacity extension scheme is used, the installed capacity of the existing hydropower station can be increased by at least 100%, and static water does not affect a lateral pressure of the water tunnel pipe; a new barrage structural member is added to fixedly bond the water tunnel pipe on the inner side of the barrage to support the weight of the water tunnel pipe and an upward static pressure in the water tunnel pipe; an opening speed and size of sealing top cover, which has the adjustable valve, at the upper end of the water tunnel pipe are subject to computer automated adjustment according to a velocity in the horizontal water tunnel pipe and a signal sent by a pressure gauge throughout a whole process from a completely closed state to a completely open state; an inner sleeve with a tapper pipe at a lower end is installed at a middle portion of the sealing top cover below a horizontal, wherein a major diameter D2 of the tapper pipe is less than an inner diameter of the water tunnel pipe by 10-20%, a ratio of a diameter d of the inner sleeve to a diameter D₂ of the sealing top cover is 0.8-0.4, and a length ratio l/H between the inner sleeve and the sealing top cover is about 0.05-0.2, forming a turbo space on an outer wall of the inner sleeve, on an inner wall of the water tunnel pipe, and below the sealing top cover, and the turbo air maintains a constant high pressure in the lower end of the water tunnel pipe; a top portion thereof is provided with a pressure sensor, and a water-surface upper portion of the inner sleeve is provided with an adjustable valve; two ends thereof are supported in two bearing blocks, wherein one end is connected to a self-clocking reducer through a coupler, another end of the reducer is connected to a motor, a speed sensor is installed at an outlet of the adjustable valve, and an opening degree of the adjustable valve is subject to computer automated control according to signals of two sensors.

2. The deep water power generation station, power station, marine power plant, and offshore floating city thereof according to claim 1, wherein a ship with a sealed enclosure can perform an underwater operation, or a ship has a double-layer casing made of the water tunnel, and a driving turbine is used to provide power to the ship; when multiple generator sets are arranged in a building, a lower portion of a platform is fixed to the seafloor through a pile; each generator set is provided with a high-speed water source by using a series of separate speed-increasing water tunnel elements or may be provided with a water source in a parallel manner; a unit power of the generator ranges from 5,000 KW to more than 1 million KW, the number of the buildings installed with generators may be 2 to more than 30, forming an offshore floating city providing a total power of tens of millions of kilowatts; in addition to power generation, the hydraulic turbine can also be connected to and drive an agricultural production apparatus; and when the horizontal speed-increasing water tunnel is not connected to the hydraulic turbine but tilts upward to inject water to a water guide groove on the land to form a water source station, the present invention is applicable to the field of rivers, lakes and oceans.

3. The deep water power generation station, power station, marine power plant, and offshore floating city thereof according to claim 2, wherein an area of the static offshore floating city may reach several square kilometers, and the offshore floating city can provide a power source for living and industrial and agricultural production of residents.

4. The deep water power generation station, power station, marine power plant, and offshore floating city thereof according to claim 1, wherein when the water tunnel pipe is connected to the ship, the water tunnel pipe is made to be a water tunnel having a water-drop-shaped cross section with a small forward resistance, and the water tunnel pipe is of a linear type or an axially contracting type.

5. The deep water power generation station, power station, marine power plant, and offshore floating city thereof according to claim 1, wherein no horizontal speed-increasing pipe is arranged at the lower end of the speed-increasing water tunnel pipe.

6. The deep water power generation station, power station, marine power plant, and offshore floating city thereof according to claim 1, wherein end surfaces of the water tunnel pipe, and the water inlet pipe are each additionally provided with an obstacle clearing apparatus with a strainer and a spiral self-rotating blade.

7. The deep water power generation station, power station, marine power plant, and offshore floating city thereof according to claim 1, wherein a means for balancing an axial force of the water tunnel pipe is: fixed bonding with the seafloor or a static object nearby, balancing with multiple suspended-cable weights or the self-weight of the ship.

8. The deep water power generation station, power station, marine power plant, and offshore floating city thereof according to claim 1, wherein a wall of the water tunnel pipe may be made into a solid with a constant thickness or strength; a solid with a trapezoid cross section, wherein an upper portion is a thick double-layer complex and a lower portion is a thin solid; a double-layer complex having a trapezoid cross section whose overall axial thickness is thin in a lower portion and thick in an upper portion.

9. The deep water power generation station, power station, marine power plant, and offshore floating city thereof according to claim 1, wherein in rivers, lakes and seas with horizontal flows, an outer wall of the water tunnel pipe is sleeved segment by segment with a flow guide sleeve pipe capable of automatically rotating around the outer wall of the water pipe, wherein an acute angle of the sleeve pipe is less than or equal to 20°; the sleeve pipe is a two-piece assembly that can be split along an axial direction to facilitate assembly and disassembly, so that a resistance system is reduced from 0.75 to 0.16; and a vertical total length is arranged segment by segment in a same manner as the water tunnel pipe.

10. The deep water power generation station, power station, marine power plant, and offshore floating city thereof according to claim 1, wherein a traction pile at a lower portion of the water tunnel pipe fixedly bonded to the seafloor is a concrete structural member, and is buried under the seafloor to avoid being affected by a water flow, the traction pile and the lower end of the water tunnel pipe may be connected by using a steel rope, or may be rigidly connected by using a rigid member with an axial window; when a depth H of the water tunnel pipe is extremely deep, in a flowing water area environment, a circumference of a conjunction of the preformed member of the water tunnel pipe is provided with a group of traction steel ropes with circumferential equal angles and vertical depression angles, the other end of each steel rope is buried in the seafloor through the traction pile; and the lower end of the water tunnel pipe is fixedly bonded on a ground pile with a radial water inlet.

11. The deep water power generation station, power station, marine power plant, and offshore floating city thereof according to claim 1, wherein when the depth of the water tunnel pipe disposed in a shallow lake or ocean is greater than a natural water depth, a deep water well may be dug at the bottom, and cobblestones or a concrete structural member is laid at the bottom of the well.

12. The deep water power generation station, power station, marine power plant, and offshore floating city thereof according to claim 1, wherein when a cylindrical and a slightly-tapered water tunnel pipe is used, an inner sleeve and a corresponding control means are arranged in the sealing top cover; in a case of a significantly-tapered water tunnel pipe, no inner sleeve is arranged in the sealing top cover, an inner side of the water tunnel pipe should be provided with a pressure sensor, and an external side of the water tunnel pipe should be provided with a valve, a support bearing block, a reducer, a motor, and a speed sensor as well as a corresponding computer automated control means.
